(19) United States
(12) Patent Application Publication
(10) Pub. No.: US 2018/0242625 A1
(43) Pub. Date: Aug. 30, 2018

(54) METHOD FOR MANUFACTURING PULVERULENT FLAVORING AGENT

(71) Applicant: TAKASAGO INTERNATIONAL CORPORATION, Tokyo (JP)

(72) Inventors: Masaharu KONO, Kanagawa (JP); Eiji EMOTO, Kanagawa (JP); Tadahiro HIRAMOTO, Kanagawa (JP)

(73) Assignee: TAKASAGO INTERNATIONAL CORPORATION, Tokyo (JP)

(21) Appl. No.: 15/756,332

(22) PCT Filed: Aug. 31, 2016
(86) PCT No.: PCT/JP2016/075419

§ 371 Date: Feb. 28, 2018

(30) Foreign Application Priority Data
Sep. 4, 2015 (JP) 2015-174703

(51) Int. Cl. A23L 27/24; A23L 3/44; A23C 19/06; A23C 19/09; A23C 9/127

(52) U.S. Cl. CPC A23L 27/25; A23L 3/44; A23V 2002/00; A23C 19/09; A23C 9/1275; A23C 19/061

(57) ABSTRACT

The present invention relates to a method for producing a powdery flavoring agent, including (1) a step of treating a milk-derived material with at least any one of a lactic acid fermentation treatment and an enzymatic reaction treatment to prepare a paste flavoring agent, (2) a step of adding an excipient to the paste flavoring agent obtained in step (1) to prepare a freeze-drying raw material liquid having a fat content in a dried solid content of 40% by mass or less, a solid content based on the excipient occupying the dried solid content of 70% by mass or less, and a water content of 20% by mass or more and less than 50% by mass, and (3) a step of subjecting the freeze-drying raw material liquid obtained in the step (2) to specific treatments to obtain the powdery flavoring agent.

### TECHNICAL FIELD

The present invention relates to a method for producing a powdery flavoring agent by a freeze-drying method from a paste flavoring agent obtained by subjecting a milk-derived material to a lactic acid fermentation treatment and/or an enzymatic reaction treatment.

### BACKGROUND ART

Conventionally, a freeze-drying method has been regarded as a preferred drying method as a drying technique for dairy products or flavorings which are easily denatured by heat because it performs drying at a relatively low temperature in comparison with other drying methods.

For example, as to the dairy products, production methods of dried cheese excellent in reconstitution property by hot water or stringiness property are disclosed in Patent Documents 1 and 2. Further, a production method of lactose-free powdered milk is disclosed in Patent Document 3, and a production method of block-like freeze-dried food containing a saccharide such as lactose is disclosed in Patent Document 4.

On the other hand, as to the flavorings, a production method of powdery flavoring formulation containing adding a flavoring component, an emulsifier and a metal salt to an aqueous gellan gum solution, followed by mixing, and freeze-drying the resulting gelled solution is disclosed in Patent Document 5.

### PRIOR ART DOCUMENT

### Patent Document

Patent Document 1: JP-A-2010-154810
Patent Document 2: JP-A-H10-248485
Patent Document 3: JP-A-H9-252723
Patent Document 4: JP-A-2011-229477
Patent Document 5: JP-A-2010-202737

### SUMMARY OF THE INVENTION

### Problems that the Invention is to Solve

The methods described in Patent Documents 1 and 2 need very complicated operations in the production, for example, cutting into an optional shape before the freeze-drying, performing slow freezing treatment or requiring a molten salt, and take a long time to carry out. The methods described in Patent Documents 3 and 4 are poor in processing properties in the pulverizing step and powder shape stability, and are also insufficient in the flavor imparting effect.

Further, since the method described in Patent Document 5 needs the addition of gellan gum or metal salt, its use is limited, and it requires a lot of works such as the preparation of gelled solution.

As described above, in the case of using conventional techniques in the production of a powdery flavoring agent by a freeze-drying from a paste flavoring agent obtained by subjecting a milk-derived material to a lactic acid fermentation treatment and/or an enzymatic reaction treatment, the problems arise in that the flavor imparting effect is considerably reduced, a freeze-dried product poor in processing properties in the pulverizing step is obtained, powder having the low shape stability is obtained, and powder is not obtained because of insufficient drying.

Therefore, an object of the present invention is to provide a method for producing a powdery flavoring agent excellent not only in the flavor imparting effect and also in properties, from a paste flavoring agent obtained by subjecting a milk-derived material to the lactic acid fermentation treatment and/or the enzymatic reaction treatment.

### Means for Solving the Problems

As a result of the intensive investigations to solve the problems described above, the present inventors have found that the powdery flavoring agent excellent not only in the flavor imparting effect and also in properties can be obtained, by performing (i) to (iv) shown below to the paste flavoring agent obtained by subjecting the milk-derived material to the lactic acid fermentation treatment and/or the enzymatic reaction treatment to prepare a freeze-drying raw material liquid and freeze-drying and pulverizing the freeze-drying raw material liquid to complete the present invention.

(i) Using a milk material(s) as an excipient
(ii) Adding the excipient such that a solid content based on the excipient occupying a dried solid content of the freeze-drying raw material liquid is 70% by mass or less
(iii) Adding the excipient such that a fat content in the dried solid content of the freeze-drying raw material liquid is 40% by mass or less
(iv) Adjusting a water content in the freeze-drying raw material liquid to 20% by mass or more and less than 50% by mass

That is, the present invention includes the following contents.

[1] A method for producing a powdery flavoring agent, including steps (1) to (3) shown below:
(1) a step of treating a milk-derived material with at least any one of a lactic acid fermentation treatment and an enzymatic reaction treatment to prepare a paste flavoring agent,
(2) a step of adding an excipient consisting of a milk material(s) to the paste flavoring agent obtained in the step (1) to prepare a freeze-drying raw material liquid having a fat content in a dried solid content of 40% by mass or less, a solid content based on the excipient occupying the dried solid content of 70% by mass or less, and a water content of 20% by mass or more and less than 50% by mass, and
(3) a step of subjecting the freeze-drying raw material liquid obtained in the step (2) to a freeze-drying and a pulverizing treatment to obtain the powdery flavoring agent.
[2] The method for producing a powdery flavoring agent as described in [1], in which the excipient in the step (2) contains lactose and a whey protein.
[3] The method for producing a powdery flavoring agent as described in [1] or [2], in which the excipient in the step (2) contains lactose and a whey protein in a ratio of from 9:1 to 1:2 by mass.
[4] The method for producing a powdery flavoring agent as described in any one of [1] to [3], in which the excipient in the step (2) contains lactose and a whey protein in a ratio of from 9:1 to 5:1 by mass.
[5] The method for producing a powdery flavoring agent as described in any one of [1] to [4], in which the enzymatic reaction treatment in the step (1) is at least one of a lipolytic enzyme treatment and a proteolytic enzyme treatment.

### Advantage of the Invention

According to a method of the present invention, a powdery flavoring agent excellent not only in a flavor imparting effect and also in properties, can be obtained by adding an excipient composed of a milk material(s) to a paste flavoring agent, adjusting a solid content based on the excipient occupying a dried solid content, a fat content in a dried solid content and a water content to specific ranges to prepare a freeze-drying raw material liquid, and subjecting the freeze-drying raw material liquid to a freeze-drying and a pulverizing treatment.

Moreover, foods and drinks having high palatability can be provided by blending the powdery flavoring agent obtained by the production method of the present invention in foods and drinks.

### MODE FOR CARRYING OUT THE INVENTION

The present invention will be described hereinafter. “To” indicating a range of the numerical values in the specification means that the range includes the numerical values described before and after the “to” as a lower limit value and an upper limit value, respectively, and unless otherwise specified, the “to” used hereinafter in the specification has the same meaning.

### <Method for Producing Powdery Flavoring Agent of Invention>

The method for producing a powdery flavoring agent of the present invention includes steps (1) to (3) shown below.

(1) A step of treating a milk-derived material with at least any one of lactic acid fermentation treatment and enzymatic reaction treatment to prepare a paste flavoring agent
(2) A step of adding an excipient composed of a milk material(s) to the paste flavoring agent obtained in the step (1) to prepare a freeze-drying raw material liquid having a fat content in a dried solid content of 40% by mass or less, a solid content based on the excipient occupying the dried solid content of 70% by mass or less, and a water content of 20% by mass or more and less than 50% by mass
(3) A step of subjecting the freeze-drying raw material liquid obtained in the step (2) to freeze-drying and pulverizing treatment to obtain the powdery flavoring agent

Each of the steps is described below.

(1) A step of treating a milk-derived material with at least any one of lactic acid fermentation treatment and enzymatic reaction treatment to prepare a paste flavoring agent

The paste flavoring agent means a paste-like flavoring agent obtained by subjecting a milk-derived material to lactic acid fermentation treatment and/or enzymatic reaction treatment. The milk-derived material referred herein includes, in addition to milk and milk products according to Ministerial Ordinance on Milk and Milk products Concerning Compositional Standards, a raw material derived from milk, for example, total milk protein (hereinafter abbreviated as TMP) [milk protein concentrate (hereinafter abbreviated as MPC), also referred to as overall milk protein].

Preferred milk-derived material includes, for example, cow milk, whole milk powder, powdered skim milk, cream, butter, butter oil, cheese, butter milk powder, (full fat) concentrated milk, skimmed concentrated milk, cream powder, whey protein concentrate (hereinafter abbreviated as WPC), and TMP. These may be used individually or may be used in combination of two kinds or more.

A lactic acid bacterium used for the lactic acid fermentation treatment is not particularly limited and includes, for example, Lactobacillus bacteria, Streptococcus bacteria, Lactococcus bacteria, Leuconostoc bacteria, and Enterococcus bacteria. The lactic acid bacteria may be used individually or may be used in combination of two kinds or more.

Temperature and time of the lactic acid fermentation treatment are not particularly limited and may be appropriately adjusted according to the kind of lactic acid bacterium or the like. The temperature is preferably from 25 to 45° C., and more preferably from 30 to 40° C. The time is preferably from 4 to 75 hours, and more preferably from 12 to 48 hours. The lactic acid fermentation treatment can be stopped by heating at a temperature and for a time commensurate with the used lactic acid bacterium to sterilize.

An enzyme used for the enzymatic reaction treatment includes, for example, a lipolytic enzyme (for example, lipase) and a proteolytic enzyme (for example, protease or peptidase).

The enzymatic reaction treatment may be only lipolytic enzyme treatment or only proteolytic enzyme treatment, or may be both of the lipolytic enzyme treatment and the proteolytic enzyme treatment. In the case where both of the lipolytic enzyme treatment and the proteolytic enzyme treatment are performed, either one may be performed first or both may be performed at the same time.

The kind of the lipolytic enzyme is not particularly limited, and lipase derived from microorganism or lipase derived from animal can be appropriately utilized. Among these lipolytic enzymes, one kind may be used individually or two kinds or more may be used in combination.

The kind of the proteolytic enzyme is not particularly limited, and microbial origin, animal origin or plant origin proteolytic enzyme can be appropriately utilized. Among these proteolytic enzymes, one kind may be used individually or two kinds or more may be used in combination. Further, any proteolytic enzyme having optimum pH in an acidic region, a neutral region or an alkaline region may be used.

Temperature and time of the enzymatic reaction treatment are not particularly limited and may be appropriately adjusted according to the kind of the enzyme. Specifically, the temperature is preferably from 20 to 50° C. The time is preferably from 2 to 96 hours. The enzymatic reaction can be stopped by heating at a temperature and for a time commensurate with inactivation conditions of the used enzyme to inactivate.

In the case where both of the lactic acid fermentation treatment and the enzymatic reaction treatment are performed, either treatment may be performed first or both may be performed at the same time.

(2) A step of adding an excipient composed of a milk material(s) to the paste flavoring agent obtained in the step (1) to prepare a freeze-drying raw material liquid having a fat content in a dried solid content of 40% by mass or less, a solid content based on the excipient occupying the dried solid content of 70% by mass or less, and a water content of 20% by mass or more and less than 50% by mass

Step (2) is a step of adding the excipient to the paste flavoring agent obtained in the step (1) such that the fat content in the dried solid content is 40% by mass or less and the solid content based on the excipient occupying the dried solid content is 70% by mass or less to prepare the freeze-drying raw material liquid in which the water content is adjusted to 20% by mass or more and less than 50% by mass.

In the present invention, only a milk material(s) is used as the excipient because the flavor imparting effect is hardly impaired. Here, the milk material refers to a material derived from milk.

The excipient is not particularly limited as long as it is the milk material. Since the excipient is added to the paste flavoring agent to adjust the fat content in the dried solid content of the obtained freeze-drying raw material liquid to 40% by mass or less, the fat content of the excipient is preferably low. The fat content of the excipient is preferably from 0 to 20% by mass, and more preferably from 0 to 10% by mass.

The milk material suitable for the excipient includes, for example, lactose, WPC (Whey Protein Concentrate), whey protein isolate (hereinafter abbreviated as WPI), TMP (Total Milk Protein), MPC (Milk Protein Concentrate), milk protein isolate (hereinafter abbreviated as MPI), whey powder, powdered skim milk, whole milk powder, and butter milk powder. These may be used individually or may be used in combination of two kinds or more.

From the standpoint of the flavor imparting effect, the excipient preferably contains lactose and whey protein. In particular, the excipient containing lactose and whey protein in a ratio of from 9:1 to 1:2 by mass provides the powdery flavoring agent excellent in not only the flavor imparting effect, but also in properties. Moreover, it is more preferred that the excipient contains lactose and whey protein in a ratio of from 9:1 to 5:1 by mass.

As the excipient containing lactose and whey protein, the milk material containing lactose, the milk material containing whey protein and the milk material containing both lactose and whey protein can be used. Further, these milk materials may be used in combination of two kinds or more thereof such that the lactose and the whey protein are in the ratio described above.

The milk material containing lactose includes, for example, lactose, whey powder, powdered skim milk, and butter milk powder. The milk material containing whey protein includes, for example, WPC, WPI and whey powder.

As to the dosage of the excipient to the paste flavoring agent, since the flavor imparting effect decreases when it is too large, the excipient is added such that the solid content based on the excipient occupying a dried solid content of the obtained freeze-drying raw material liquid is 70% by mass or less. The solid content based on the excipient occupying the dried solid content of the freeze-drying raw material liquid is preferably 60% by mass or less, and more preferably 55% by mass or less.

When the dosage of the excipient to the paste flavoring agent is too small, sufficient effect as the excipient cannot be obtained, and stickiness occurs at pulverization so that no powder can be obtained. Therefore, the solid content based on the excipient occupying the dried solid content is preferably 5% by mass or more, and more preferably 10% by mass or more.

The fat content in the dried solid content of the freeze-drying raw material liquid obtained after the addition of the excipient is 40% by mass or less. The lower limit is not particularly limited and it is usually 1% by mass or more.

By setting the fat content to 40% by mass or less, processing properties in the pulverizing step carried out after freeze-drying and powder shape stability can be enhanced. In the case where the fat content in the dried solid content is more than 40% by mass, drying does not proceeds or stickiness occurs at pulverization so that no powder can be obtained.

The water content in the freeze-drying raw material liquid obtained after the addition of the excipient is 20% by mass or more and less than 50% by mass, and preferably 25% by mass or more and less than 50% by mass.

By setting the water content to 20% by mass or more and less than 50% by mass, the processing properties in the pulverizing step can be enhanced without impairing the flavor imparting effect. In the case where the water content is less than 20% by mass, the processing properties in the preparation step of freeze-drying raw material liquid and the pulverizing step become extremely poor.

When the water content is 50% by mass or more, the drying step takes not only cost but also time and needs higher vacuum degree so that the flavor imparting effect is impaired. Further, water may be added, if necessary, so as to reach the range described above.

A sterilization step may be put after addition and adjustment of the excipient, but it is preferred not to heat more than necessary in order not to impair the flavor imparting effect. Specifically, such sterilization conditions include, for example, “at 63 to 68° C. for 30 minutes”.

Further, emulsification may be carried out with a high-pressure homogenizer, a TK homogenizer or the like, and a stabilizer or an emulsifier may be added, if necessary. However, it is preferred to avoid use of molten salt because low sodium and low phosphide products are desired from the increase of health consciousness in recent years.

(3) A step of subjecting the freeze-drying raw material liquid obtained in the step (2) to freeze-drying and pulverizing treatment to obtain the powdery flavoring agent

The prepared freeze-drying raw material liquid is filled in a container having a predetermined size and pre-frozen. The pre-freezing conditions are not particularly limited, and specifically, temperature is preferably from −15 to −80° C., more preferably from −15 to −40° C., and time is from 3 to 48 hours.

The pre-frozen product may be provided to a freeze-drying apparatus and freeze-dried. As the freeze-drying apparatus, a commercially available one can be used. The freeze-drying conditions are not particularly limited and specifically, for example, vacuum degree is preferably 1 Pa or more and 200 Pa or less, more preferably 5 Pa or more and 130 Pa or less, and drying temperature is preferably from 20 to 60° C.

After drying, pulverizing treatment and sieving are performed to obtain the powdery flavoring agent of the present invention. Methods of the pulverizing step and sieving are not particularly limited, and it is preferred to suppress frictional heat in order not to affect the flavor imparting effect and physical properties.

### <Powdery Flavoring Agent>

The powdery flavoring agent obtained by the production method of the present invention can be used as it is as a flavoring material. Further, it can be blended with optional other components. The optional other components include, for example, solid seasoning, powdery flavoring and flavoring composition, and solid diluent. The powdery flavoring agent of the present invention can be processed into a granular form.

The powdery flavoring agent obtained by the production method of the present invention can be blended in the production step of food and drink. The food and drink to which the powdery flavoring agent can be blended are not particularly limited and include a wide range of foods and drinks, for example, various drinks, frozen desserts, baked confectioneries, dairy products, and cooked foods.

Specifically, they include, for example, coffee, cafe au lait, milk tea, yogurt drink, milk drink, ice cream, ice milk, facto ice, frozen confection, cheese, yogurt, lactic acid bacteria drink, pudding, mousse, cake, cookie, snack, gum, candy, dressing, seasoning, stew, curry, filling, and cream.

The dosage of the powdery flavoring agent obtained by the production method of the present invention blended to food and drink is not particularly limited and can be appropriately adjusted depending on the kind of the food and drink. Usually, it is preferably in a range from 0.005 to 0.5% by mass, more preferably from 0.01 to 0.3% by mass, with respect to the total mass of the food and drink.

The powdery flavoring agent obtained by the production method of the present invention can impart “natural feeling”, “fresh feeling”, “thickness”, or “long-lasting”, which milk has, to food and drink. Further, improvement in the palatability of food and drink can be achieved by adding the powdery flavoring agent obtained by the production method of the present invention to the food and drink.

Hereinafter, the present invention will be described more specifically with reference to the Examples, but the present invention should not be construed as being limited to those Examples.

### EXAMPLE

### (Production Example 1) Preparation of a Paste Flavoring Agent A

To 90 g of cheddar cheese (produced by Fonterra Co.) which had been pulverized was added an enzyme solution obtained by dissolving 0.5 g of protease A2SD (produced by Amano Enzyme Inc.) and 0.01 g of lipase AY (produced by Amano Enzyme Inc.) in 9.49 g of ion-exchanged water, followed by stirring at 40° C. for 40 hours to perform an enzyme treatment. Then, heat inactivation at 85° C. for 20 minutes was performed, followed by homogenizing (8,000 rpm, 10 minutes, 70 to 80° C.) by HOMOGENIZING MIXER MARK II Model 2.5 (produced by Primix Corp.) to obtain the paste flavoring agent A.

### (Production Example 2) Preparation of a Paste Flavoring Agent B

To 85 g of Kraft 100% Parmesan cheese powder was added an enzyme solution obtained by dissolving 0.9 g of protease A2SD (produced by Amano Enzyme Inc.) and 0.1 g of lipase AY (produced by Amano Enzyme Inc.) in 14 g of ion-exchanged water, followed by stirring at 40° C. for 40 hours to perform an enzyme treatment. Then, heat inactivation at 85° C. for 20 minutes was performed, followed by homogenizing (8,000 rpm, 10 minutes, 70 to 80° C.) by HOMOGENIZING MIXER MARK II Model 2.5 (produced by Primix Corp.) to obtain the paste flavoring agent B.

### (Production Example 3) Preparation of a Paste Flavoring Agent C

To a whole milk powder solution obtained by dissolving 40 g of whole milk powder (produced by Takanashi Milk Products Co., Ltd.) in 55 g of water and then sterilizing at 85° C. for 20 minutes was added 3 g of lactic acid bacteria seed (L. acidophilus), followed by standing at 35° C. for 20 hours to perform lactic acid fermentation. After sterilizing by heating at 85° C. for 20 minutes, an enzyme solution obtained by dissolving 0.2 g of protease A2SD (produced by Amano Enzyme Inc.) and 0.1 g of lipase AY30SD (produced by Amano Enzyme Inc.) in 1.7 g of ion-exchanged water was added thereto, followed by stirring at 40° C. for 20 hours to perform an enzyme treatment. Then, heat inactivation at 85° C. for 20 minutes was performed, followed by homogenizing (8,000 rpm, 10 minutes, 70 to 80° C.) by HOMOGENIZING MIXER MARK II Model 2.5 (produced by Primix Corp.) to obtain the paste flavoring agent C.

### Example 1

To 61.3 g of the paste flavoring agent A were added an excipient [lactose:whey protein=9:1 (mass ratio)] composed of 13.5 g of lactose (produced by Leprino Foods Co.) and 1.9 g of WPC 80 (produced by Warrnambool Co.) and 23.3 g of ion-exchanged water, followed by sterilizing by heating at 65° C. for 30 minutes and homogenizing (10 MPa, 65° C.) by a high-pressure homogenizer (ECONIZER LABO-01 produced by Sanmaru Machinery Co., Ltd.) to prepare a freeze-drying raw material liquid A. The freeze-drying raw material liquid A was frozen at −30° C. for one night, dried by using a freeze dryer (FDU-2100, DRC-1000, produced by Tokyo Rikakikai Co., Ltd.) under a reduced pressure of 7.5 Pa and at 30° C. for 24 hours, and then subjected to a pulverizing step to obtain a powdery flavoring agent A.

### Example 2

To 61.3 g of the paste flavoring agent A were added an excipient [lactose:whey protein=5:1 (mass ratio)] composed of 12.3 g of lactose (produced by Leprino Foods Co.) and 3.1 g of WPC 80 (produced by Warrnambool Co.) and 23.3 g of ion-exchanged water, followed by sterilizing by heating at 65° C. for 30 minutes and homogenizing (10 MPa, 65° C.) by the high-pressure homogenizer (ECONIZER LABO-01 produced by Sanmaru Machinery Co., Ltd.) to prepare a freeze-drying raw material liquid B. The freeze-drying raw material liquid B was frozen at −30° C. for one night, dried by using the freeze dryer (FDU-2100, DRC-1000, produced by Tokyo Rikakikai Co., Ltd.) under a reduced pressure of 7.5 Pa and at 30° C. for 24 hours, and then subjected to a pulverizing step to obtain a powdery flavoring agent B.

### Example 3

To 60.1 g of the paste flavoring agent A were added an excipient [lactose:whey protein=1:2 (mass ratio)] composed of 3.8 g of lactose (produced by Leprino Foods Co.) and 12.4 g of WPC 80 (produced by Warmambool Co.) and 23.7 g of ion-exchanged water, followed by sterilizing by heating at 65° C. for 30 minutes and homogenizing (10 MPa, 65° C.) by the high-pressure homogenizer (ECONIZER LABO-01 produced by Sanmaru Machinery Co., Ltd.) to prepare a freeze-drying raw material liquid C. The freeze-drying raw material liquid C was frozen at −30° C. for one night, dried by using the freeze dryer (FDU-2100, DRC-1000, produced by Tokyo Rikakikai Co., Ltd.) under a reduced pressure of 7.5 Pa and at 30° C. for 24 hours, and then subjected to a pulverizing step to obtain a powdery flavoring agent C.

### Example 4

To 92.0 g of the paste flavoring agent B was added an excipient [lactose:whey protein=6:1 (mass ratio)] composed of 6.6 g of lactose (produced by Leprino Foods Co.) and 1.4 g of WPC 80 (produced by Warmambool Co.), followed by sterilizing by heating at 65° C. for 30 minutes and homogenizing (10 MPa, 65° C.) by the high-pressure homogenizer (ECONIZER LABO-01 produced by Sanmaru Machinery Co., Ltd.) to prepare a freeze-drying raw material liquid D. The freeze-drying raw material liquid D was frozen at −30° C. for one night, dried by using the freeze dryer (FDU-2100, DRC-1000, produced by Tokyo Rikakikai Co., Ltd.) under a reduced pressure of 7.5 Pa and at 30° C. for 24 hours, and then subjected to a pulverizing step to obtain a powdery flavoring agent D.

### Example 5

To 80.0 g of the paste flavoring agent C was added an excipient [lactose:whey protein=5:1 (mass ratio)] composed of 16.0 g of lactose (produced by Leprino Foods Co.) and 4.0 g of WPC 80 (produced by Warrnambool Co.), followed by sterilizing by heating at 65° C. for 30 minutes and homogenizing (10 MPa, 65° C.) by the high-pressure homogenizer (ECONIZER LABO-01 produced by Sanmaru Machinery Co., Ltd.) to prepare a freeze-drying raw material liquid E. The freeze-drying raw material liquid E was frozen at −30° C. for one night, dried by using the freeze dryer (FDU-2100, DRC-1000, produced by Tokyo Rikakikai Co., Ltd.) under a reduced pressure of 7.5 Pa and at 30° C. for 24 hours, and then subjected to a pulverizing step to obtain a powdery flavoring agent E.

### Comparative Example 1

To 65.0 g of the paste flavoring agent A were added an excipient [lactose:whey protein=1:1 (mass ratio)] composed of 5.5 g of lactose (produced by Leprino Foods Co.) and 8.0 g of WPC 80 (produced by Warrnambool Co.) and 21.5 g of ion-exchanged water, followed by sterilizing by heating at 65° C. for 30 minutes and homogenizing (10 MPa, 65° C.) by the high-pressure homogenizer (ECONIZER LABO-01 produced by Sanmaru Machinery Co., Ltd.) to prepare a freeze-drying raw material liquid F. The freeze-drying raw material liquid F was frozen at −30° C. for one night and dried by using the freeze dryer (FDU-2100, DRC-1000, produced by Tokyo Rikakikai Co., Ltd.) under a reduced pressure of 7.5 Pa and at 30° C. for 24 hours to thoroughly remove the moisture, but the resulting material was severely sticky and could not proceed to a pulverizing step.

### Comparative Example 2

To 24.5 g of the paste flavoring agent A were added an excipient [lactose:whey protein=1:0.83 (mass ratio)] composed of 17.5 g of lactose (produced by Leprino Foods Co.) and 20.5 g of WPC 80 (produced by Warrnambool Co.) and 37.5 g of ion-exchanged water, followed by sterilizing by heating at 65° C. for 30 minutes and homogenizing (10 MPa, 65° C.) by the high-pressure homogenizer (ECONIZER LABO-01 produced by Sanmaru Machinery Co., Ltd.) to prepare a freeze-drying raw material liquid G. The freeze-drying raw material liquid G was frozen at −30° C. for one night, dried by using the freeze dryer (FDU-2100, DRC-1000, produced by Tokyo Rikakikai Co., Ltd.) under a reduced pressure of 7.5 Pa and at 30° C. for 24 hours, and then subjected to a pulverizing step to obtain a powdery flavoring agent G.

### Comparative Example 3

Without adding an excipient and the like, 100 g of the paste flavoring agent B was sterilized by heating at 65° C. for 30 minutes and homogenized (10 MPa, 65° C.) by the high-pressure homogenizer (ECONIZER LABO-01 produced by Sanmaru Machinery Co., Ltd.) to prepare a freeze-drying raw material liquid H. The freeze-drying raw material liquid H was frozen at −30° C. for one night, dried by using the freeze dryer (FDU-2100, DRC-1000, produced by Tokyo Rikakikai Co., Ltd.) under a reduced pressure of 7.5 Pa and at 30° C. for 24 hours to thoroughly remove the moisture, but the resulting material was severely sticky and could not proceed to a pulverizing step.

### Comparative Example 4

To 50.0 g of the paste flavoring agent B were added an excipient composed of 15.0 g of dextrin NSD300 (produced by San-ei Sucrochemical Co., Ltd.) and 35.0 g of ion-exchanged water, followed by sterilizing by heating at 65° C. for 30 minutes and homogenizing (10 MPa, 65° C.) by the high-pressure homogenizer (ECONIZER LABO-01 produced by Sanmaru Machinery Co., Ltd.) to prepare a freeze-drying raw material liquid I. The freeze-drying raw material liquid I was frozen at −30° C. for one night, dried by using the freeze dryer (FDU-2100, DRC-1000, produced by Tokyo Rikakikai Co., Ltd.) under a reduced pressure of 7.5 Pa and at 30° C. for 24 hours, and then subjected to a pulverizing step to obtain a powdery flavoring agent I.

### Comparative Example 5

To 65.0 g of the paste flavoring agent B was added an excipient [lactose:whey protein=1:1 (mass ratio)] composed of 14.5 g of lactose (produced by Leprino Foods Co.) and 20.5 g of WPC 80 (produced by Warrnambool Co.), followed by sterilizing by heating at 65° C. for 30 minutes and homogenizing (10 MPa, 65° C.) by the high-pressure homogenizer (ECONIZER LABO-01 produced by Sanmaru Machinery Co., Ltd.), but a uniform freeze-drying raw material liquid J could not be prepared.

For reference, the freeze-drying raw material liquid J was frozen at −30° C. for one night, dried by using the freeze dryer (FDU-2100, DRC-1000, produced by Tokyo Rikakikai Co., Ltd.) under a reduced pressure of 7.5 Pa and at 30° C. for 24 hours to thoroughly remove the moisture, but drying was extremely uneven and the resulting material could not proceed to a pulverizing step.

### Comparative Example 6

To 60.0 g of the paste flavoring agent B were added an excipient [lactose:whey protein=1:1 (mass ratio)] composed of 2.5 g of lactose (produced by Leprino Foods Co.) and 3.5 g of WPC 80 (produced by Warrnambool Co.) and 34.0 g of ion-exchanged water, followed by sterilizing by heating at 65° C. for 30 minutes and homogenizing (10 MPa, 65° C.) by the high-pressure homogenizer (ECONIZER LABO-01 produced by Sanmaru Machinery Co., Ltd.) to prepare a freeze-drying raw material liquid K. The freeze-drying raw material liquid K was frozen at −30° C. for one night, dried by using the freeze dryer (FDU-2100, DRC-1000, produced by Tokyo Rikakikai Co., Ltd.) under a reduced pressure of 7.5 Pa and at 30° C. for 24 hours, and then subjected to a pulverizing step to obtain a powdery flavoring agent K.

### (Test Example 1) Evaluation of Physical Property of Powder

As to appearance of the obtained powdery flavoring agent and the cases where powders could not be obtained in Examples 1 to 5 and Comparative Examples 1 to 6, the evaluation was performed according to evaluation points (4 stages) shown in Table 1. The results are shown in Tables 4 and 5.

### (Test Example 2) Evaluation of Intensity of Flavor Imparting Effect

Each of the powdery flavoring agents A to E obtained in Examples 1 to 5 and the powdery flavoring agents G, I and K obtained in Comparative Examples 2, 4 and 6 was added to water in an amount of 0.1% by mass to prepare a drinking water. As a control, each of the paste flavoring agents A to C obtained in Production Examples 1 to 3 was added to water in an amount of 0.1% by mass to prepare a drinking water. Each of the drinking water was tasted by seven expert panelists and the intensity of flavor was evaluated according to evaluation points (1 to 9 points) shown in Table 2.

The evaluation was performed by comparing each drinking water prepared by using each of the powdery flavoring agents of the Examples and Comparative Examples with each drinking water prepared by using each the paste flavoring agents (Production Examples 1 to 3) which were the raw materials of the powdery flavoring agents used in the each drinking water. An average value of the evaluation points by the seven expert panelists was indicated as the result. The results are shown in Tables 4 and 5.

### (Test Example 3) Evaluation of Flavor Imparting Effect

Each of powdery flavoring agents A to E obtained in Examples 1 to 5 and powdery flavoring agents G, I and K obtained in Comparative Examples 2, 4 and 6 was added to food and drink (cream stew, cafe au lait, lacto ice, or chiffon cake) in an amount of 0.1% by mass to prepare each food and drink according to a conventional method.

As a control, each of paste flavoring agents A to C obtained in Production Examples 1 to 3 was added to food and drink (cream stew, cafe au lait, lacto ice, or chiffon cake) in an amount of 0.1% by mass to prepare each food and drink according to a conventional method.

Each of the foods and drinks was tasted by seven expert panelists and natural feeling, fresh feeling, thickness, long-lasting, and palatability were evaluated according to evaluation points (0 to 9 points) shown in Table 3.

The evaluation was performed by comparing each of the foods and drinks prepared by using each of the powdery flavoring agents of the Examples and Comparative Examples with each of the foods and drinks prepared by using each of the paste flavoring agents (Production Examples 1 to 3) which were the raw materials of the powdery flavoring agents used in each of the foods and drinks. An average value of the evaluation points by the seven expert panelists was indicated as the result. The results are shown in Tables 4 and 5.

In Table 4, the dried solid content of the freeze-drying raw material liquid was measured by an ordinary pressure drying method, the fat content was measured by a Roese-Gottlieb method or a Gerber method, the solid content based on the excipient was measured by the ordinary pressure drying method, and the water content was measured by the ordinary pressure drying method.

TABLE 1

| Evaluation Point | Evaluation |
|---|---|
| ⊙ | Extremely smooth and dry powder form |
| ◯ | Smooth and dry powder form |
| Δ | Sticky powder form |
| X | Unable to dry or unable to pulverize |

TABLE 2

| Evaluation | |
|---|---|
| Point | Evaluation |
| 9 | Exactly same as product containing paste flavoring |
| | agent |
| 8 | Very slightly weak in comparison with product |
| | containing paste flavoring agent |
| 7 | Slightly weak in comparison with product containing |
| | paste flavoring agent |
| 6 | A little bit weak in comparison with product containing |
| | paste flavoring agent |
| 5 | Somewhat weak in comparison with product containing |
| | paste flavoring agent |
| 4 | Weak in comparison with product containing paste |
| | flavoring agent |
| 3 | Very weak in comparison with product containing |
| | paste flavoring agent, and flavor imparting effect is |
| | not so much exhibited |
| 2 | Extremely weak in comparison with product containing |
| | paste flavoring agent, and flavor imparting effect is |
| | almost not exhibited |
| 1 | Same as no addition |

TABLE 3

| Evaluation | |
|---|---|
| Point | Evaluation |
| 9 | Exactly same as product containing paste flavoring agent |
| 8 | Very slightly degraded in comparison with product |
| | containing paste flavoring agent |
| 7 | Slightly degraded in comparison with product containing |
| | paste flavoring agent |
| 6 | A little bit degraded in comparison with product containing |
| | paste flavoring agent |
| 5 | Somewhat degraded in comparison with product containing |
| | paste flavoring agent |
| 4 | Degraded in comparison with product containing paste |
| | flavoring agent |
| 3 | Very degraded in comparison with product containing |
| | paste flavoring agent |
| 2 | Extremely degraded in comparison with product containing |
| | paste flavoring agent, and flavor imparting effect is |
| | almost not exhibited |
| 1 | Same as no addition |
| 0 | Negative effect is felt by addition |

TABLE 4

| | | | | | | Com. | |
|---|---|---|---|---|---|---|---|
| | | Ex. 1 | Ex. 2 | Ex. 3 | | Ex. 2 | Ex. 4 |
| | | (Powdery | (Powdery | (Powdery | | (Powdery | (Powdery |
| | | flavoring | flavoring | flavoring | Com. | flavoring | flavoring |
| | | agent A) | agent B) | agent C) | Ex. 1 | agent G) | agent D) |
| Component | Paste flavoring | 61.3 | 61.3 | 60.1 | 65.0 | 24.5 | — |
| (g) | agent A | | | | | | |
| | (Production Ex. 1) | | | | | | |
| | Paste flavoring | — | — | — | — | — | 92.0 |
| | agent B | | | | | | |
| | (Production Ex. 2) | | | | | | |
| | Paste flavoring | — | — | — | — | — | — |
| | agent C | | | | | | |
| | (Production Ex. 3) | | | | | | |
| | Lactose | 13.5 | 12.3 | 3.8 | 5.5 | 17.5 | 6.6 |
| | WPC 80 | 1.9 | 3.1 | 12.4 | 8.0 | 20.5 | 1.4 |
| | Dextrin | — | — | — | — | — | — |
| | Ion-exchanged | 23.3 | 23.3 | 23.7 | 21.5 | 37.5 | — |
| | water | | | | | | |
| | Total | 100 | 100 | 100 | 100 | 100 | 100 |
| | Lactose: Whey | 9:1 | 5:1 | 1:2 | 1:1 | 1:0.83 | 6:1 |
| | protein | | | | | | |
| | (mass ratio) | | | | | | |
| Freeze-drying | Water content | 48.99 | 48.99 | 48.99 | 48.63 | 49.49 | 25.81 |
| raw material | Fat content in | 39.76 | 39.88 | 39.98 | 42.42 | 17.93 | 35.93 |
| liquid | dried solid content | | | | | | |
| | (% by mass) | | | | | | |
| | Solid content | 28.63 | 28.62 | 30.02 | 24.86 | 71.19 | 10.22 |
| | based on excipient | | | | | | |
| | in dried solid | | | | | | |
| | content | | | | | | |
| | (% by mass) | | | | | | |

| | | | Com. | | Com. | |
|---|---|---|---|---|---|---|
| | | | Ex. 4 | | Ex. 6 | Ex. 5 |
| | | | (Powdery | | (Powdery | (Powdery |
| | | Com. | flavoring | Com. | flavoring | flavoring |
| | | Ex. 3 | agent I) | Ex. 5 | agent K) | agent E) |
| Component | Paste flavoring | — | — | — | — | — |
| (g) | agent A | | | | | |
| | (Production Ex. 1) | | | | | |
| | Paste flavoring | 100.0 | 50.0 | 65.0 | 60.0 | — |
| | agent B | | | | | |
| | (Production Ex. 2) | | | | | |
| | Paste flavoring | — | — | — | — | 80.0 |
| | agent C | | | | | |
| | (Production Ex. 3) | | | | | |
| | Lactose | — | — | 14.5 | 2.5 | 16.0 |
| | WPC 80 | — | — | 20.5 | 3.5 | 4.0 |
| | Dextrin | — | 15.0 | — | — | — |
| | Ion-exchanged | — | 35.0 | — | 34.0 | — |
| | water | | | | | |
| | Total | 100 | 100 | 100 | 100 | 100 |
| | Lactose: Whey | | | | | |
| | protein | | | 1:1 | 1:1 | 5:1 |
| | (mass ratio) | | | | | |
| Freeze-drying | Water content | 27.60 | 49.70 | 19.83 | 50.88 | 49.47 |
| raw material | Fat content in dried | 39.92 | 28.73 | 24.66 | 35.65 | 16.53 |
| liquid | solid content | | | | | |
| | (% by mass) | | | | | |
| | Solid content | 0 | 28.03 | 41.30 | 11.56 | 37.52 |
| | based on excipient | | | | | |
| | in dried solid | | | | | |
| | content | | | | | |
| | (% by mass) | | | | | |

TABLE 5

| | | | | | | Com. | | |
|---|---|---|---|---|---|---|---|---|
| | | Ex. 1 | Ex. 2 | Ex. 3 | | Ex. 2 | Ex. 4 | |
| | | (Powdery | (Powdery | (Powdery | | (Powdery | (Powdery | |
| | | flavoring | flavoring | flavoring | | flavoring | flavoring | |
| | | agent | agent | agent | Com. | agent | agent | |
| | | A) | B) | C) | Ex. 1. | G) | D) | |
| Physical property | | ◯ | ◯ | ◯ | X | ◯ | ◯ | |
| (Test Ex. 1) | | | | | | | | |
| Flavor intensity | | 8.3 | 8.3 | 7.1 | — | 2.0 | 8.6 | |
| when added to | | | | | | | | |
| water | | | | | | | | |
| (Test Ex. 2) | | | | | | | | |
| Food and drink | | Cream stew | Cream stew | Cream stew | — | Cream stew | Cream stew | |
| to be added | | | | | | | | |
| (Test Ex. 3) | | | | | | | | |
| Evaluation | Natural feeling | 8.7 | 8.7 | 6.4 | | 2.3 | 8.6 | |
| items | Fresh feeling | 8.6 | 8.7 | 6.1 | — | 2.3 | 8.7 | |
| | Thickness | 8.1 | 8.6 | 6.6 | — | 1.9 | 8.9 | |
| | Long-lasting | 8.0 | 8.7 | 6.6 | — | 1.7 | 8.7 | |
| | Palatability | 8.3 | 8.7 | 6.3 | — | 2.0 | 8.7 | |
| Remarks | | Balance | Balance | Balance | Product | Strength is | Balance | |
| | | is good and | is good and | is good and | adhered | week and | is good and | |
| | | palatability | palatability | palatability | to pulverizer | flavor | palatability | |
| | | is extremely | is extremely | is high | and powers | balance is | is extremely | |
| | | high | high | | could not | collapsed | high | |
| | | | | | be obtained | | | |
| | | | Com. | | Com. | | | |
| | | | Ex. 4 | | Ex. 6 | | | |
| | | | (Powdery | | (Powdery | | | |
| | | | flavoring | | flavoring | | | |
| | | Com. | agent | Com. | agent | Ex. 5 | | |
| | | Ex. 3 | I) | Ex. 5 | K) | (Powdery flavoring agent E) | | |
| Physical property | | X | ◯ | X | ◯ | ⊙ | | |
| (Test Ex. 1) | | | | | | | | |
| Flavor intensity | | — | 3.0 | — | 3.0 | 8.0 | | |
| when added to | | | | | | | | |
| water | | | | | | | | |
| (Test Ex. 2) | | | | | | | | |
| Food and drink | | — | Cream stew | — | Cream stew | Cafe au lait | Lacto ice | Chiffon cake |
| to be added | | | | | | | | |
| (Test Ex. 3) | | | | | | | | |
| Evaluation | Natural feeling | — | 1.4 | — | 2.4 | 8.7 | 8.6 | 8.7 |
| items | Fresh feeling | — | 1.7 | — | 2.6 | 8.3 | 8.1 | 8.3 |
| | Thickness | — | 1.4 | — | 2.9 | 8.6 | 8.6 | 8.7 |
| | Long-lasting | — | 1.4 | — | 2.8 | 8.7 | 8.7 | 8.3 |
| | Palatability | — | 1.4 | — | 2.7 | 8.7 | 8.6 | 8.7 |

| | | | | | | | |
|---|---|---|---|---|---|---|---|
| Remarks | Powders | Imbalance | Uniform | Both strength | Balance | Balance | Balance |
| | could | is perceived | freeze-drying | and odor | is good and | is good and | is good and |
| | not be | and | raw material | quality are | palatability | palatability | palatability |
| | obtained | unnatural | liquid could | considerably | is extremely | is extremely | is extremely |
| | | feeling | not be | decreased | high | high | high |
| | | | obtained | | | | |
| | | | and drying | | | | |
| | | | unable to be | | | | |
| | | | performed | | | | |

As shown in Tables 4 and 5, it was confirmed that the powdery flavoring agent obtained by adding the excipient composed of the milk material(s) to the paste flavoring agent to prepare the freeze-drying raw material liquid such that the fat content in the dried solid content is 40% by mass or less, the solid content based on the excipient occupying the dried solid content is 70% by mass or less, and the water content is 20% by mass or more and less than 50% by mass, and then freeze-drying and pulverizing the freeze-drying raw material liquid has excellent flavor imparting effect and powder properties.

The present invention is described in detail with reference to specific embodiments, but it is apparent for those skilled in the art that various changes or modifications can be added without departing from the spirit and the scope of the present invention. This application is based upon Japanese Patent Application (No. 2015-174703) filed on Sep. 4, 2015, the contents of which are incorporated herein by reference.

### INDUSTRIAL APPLICABILITY

According to the production method of the present invention, a powdery flavoring agent having excellent properties and flavor imparting effect can be provided. The powdery flavoring agent obtained by the production method of the present invention is effective for improving flavor of various foods and drinks, and has applicability in the food industry.

1. A method for producing a powdery flavoring agent, comprising steps (1) to (3) shown below:
(1) a step of treating a milk-derived material with at least any one of a lactic acid fermentation treatment and an enzymatic reaction treatment to prepare a paste flavoring agent,
(2) a step of adding an excipient consisting of a milk material(s) to the paste flavoring agent obtained in the step (1) to prepare a freeze-drying raw material liquid having a fat content in a dried solid content of 40% by mass or less, a solid content based on the excipient occupying the dried solid content of 70% by mass or less, and a water content of 20% by mass or more and less than 50% by mass, and
(3) a step of subjecting the freeze-drying raw material liquid obtained in the step (2) to a freeze-drying and a pulverizing treatment to obtain the powdery flavoring agent.

2. The method for producing a powdery flavoring agent according to claim 1, wherein the excipient in the step (2) comprises lactose and a whey protein.

3. The method for producing a powdery flavoring agent according to claim 1, wherein the excipient in the step (2) comprises lactose and a whey protein in a ratio of from 9:1 to 1:2 by mass.

4. The method for producing a powdery flavoring agent according to claim 1, wherein the excipient in the step (2) comprises lactose and a whey protein in a ratio of from 9:1 to 5:1 by mass.

5. The method for producing a powdery flavoring agent according to claim 1, wherein the enzymatic reaction treatment in the step (1) is at least one of a lipolytic enzyme treatment and a proteolytic enzyme treatment.

6. The method for producing a powdery flavoring agent according to claim 2, wherein the enzymatic reaction treatment in the step (1) is at least one of a lipolytic enzyme treatment and a proteolytic enzyme treatment.

7. The method for producing a powdery flavoring agent according to claim 3, wherein the enzymatic reaction treatment in the step (1) is at least one of a lipolytic enzyme treatment and a proteolytic enzyme treatment.

8. The method for producing a powdery flavoring agent according to claim 4, wherein the enzymatic reaction treatment in the step (1) is at least one of a lipolytic enzyme treatment and a proteolytic enzyme treatment.
